(19) United States
(12) Patent Application Publication
(10) Pub. No.: US 2014/0222290 A1
(43) Pub. Date: Aug. 7, 2014

(54) ROTARY ELECTRIC MACHINE CONTROL APPARATUS AND ELECTRIC POWER STEERING SYSTEM USING THE SAME

(71) Applicant: DENSO CORPORATION, Kariya-city (JP)

(72) Inventors: Takahiro YAMANAKA, Kariya-city (JP); Nobuhisa YAMAGUCHI, Nagoya-city (JP)

(73) Assignee: DENSO CORPORATION, Kariya-city (JP)

(21) Appl. No.: 14/053,928

(22) Filed: Oct. 15, 2013

(30) Foreign Application Priority Data
Feb. 5, 2013 (JP) 2013-20380

(51) Int. Cl. H02P 6/18; B62D 5/04

(52) U.S. Cl. CPC H02P 6/182; B62D 5/0463
USPC 701/41; 318/400.34

(57) ABSTRACT

Comparators of a rotary electric machine control apparatus acquire terminal voltages of each phase, which are developed at junction points between high-potential side FETs and low-potential side FETs, respectively. In switching over ON and OFF of the high-potential side FETs and the low-potential side FETs, a control unit determines a flow direction of a phase current supplied to each phase coil based on a terminal voltage developed in a dead time period, in which a the high-potential side FET and the low-potential side FET forming a pair are both turned off. Thus, the flow direction of each phase current is determined in a simple configuration.

### CROSS REFERENCE TO RELATED APPLICATION

This application is based on and incorporates herein by reference Japanese patent application No. 2013-20380 filed on Feb. 5, 2013.

### FIELD

The present disclosure relates to a rotary electric machine control apparatus and an electric power steering system using the same.

### BACKGROUND

A conventional rotary electric machine control apparatus controls driving of a rotary electric machine by detecting an electric current flowing in each phase coils by an electronic component such as a current sensor. In JP-A-2005-210871, for example, a phase current is detected by a shunt resistor, which is provided in each switching element pair corresponding to each phase of an inverter.

The rotary electric machine includes inductive components and the like. A phase difference hence arises between a command current for driving the rotary electric machine and an actual current flowing in the coil of the rotary electric machine. The phase difference tends to cause that a torque outputted from the rotary electric machine does not attain a required torque level. For this reason, according to the conventional rotary electric machine control apparatus, the rotary electric machine is feedback-controlled. In the feedback control, the torque generated by the rotary electric machine is controlled by detecting the phase difference between the actual current flowing in the rotary electric machine and the command current and correcting the phase difference by a phase compensation control or the like.

However, in a case that electronic components such as the shunt resistor for detecting the actual current are provided, the configuration of the control apparatus becomes complicated and large-sized.

### SUMMARY

It is therefore an object to provide a rotary electric machine control apparatus, which is capable of detecting a direction of a current supplied to each phase coil of a rotary electric machine in a simple configuration, and an electric power steering system using the same.

According to one aspect, a rotary electric machine control apparatus is provided for controlling driving of a rotary electric machine, which includes a winding set formed of plural coils corresponding to plural phases. The rotary electric machine control apparatus comprises an inverter and a control unit. The inverter includes switching elements forming plural switching element pairs, each of which corresponds to each phase of the coils and is formed of a first switching element provided at a high-potential side and a second switching element provided at a low-potential side. The control unit includes a terminal voltage acquisition part, a drive control part and a current flow direction determination part. The terminal voltage acquisition part acquires a terminal voltage developed at each junction point, which is between the first switching element and the second switching element and connected to one end of the coil of the corresponding phase. The drive control part controls the driving of the rotary electric machine by controlling ON-OFF operations of the switching elements based on a command current related to the driving of the rotary electric machine. The current flow direction determination part determines, at time of an ON-OFF switchover of the first switching element and the second switching element, a current flow direction of an actual current flowing in the coil of the phase corresponding to the terminal voltage based on the terminal voltage developed in a dead time period, in which the pair of the first switching element and the second switching element are both turned off.

### BRIEF DESCRIPTION OF THE DRAWINGS

FIG. 1 is a block diagram showing a rotary electric machine control apparatus according to a first embodiment;

FIG. 2 is a schematic view showing an electric power steering system using the rotary electric machine control apparatus according to the first embodiment;

FIGS. 3A and 3B are explanatory diagrams showing current flow directions of actual currents in the first embodiment;

FIG. 4 is a time chart showing a method of determination of the flow direction according to the first embodiment; and

FIG. 5 is a time chart showing a method of determination of the flow direction according to a second embodiment.

### EMBODIMENT

A rotary electric machine control apparatus will be described below with reference to plural embodiments shown in the drawings, in which substantially the same configuration parts are designated by the same reference numerals thereby to simplify the description.

### First Embodiment

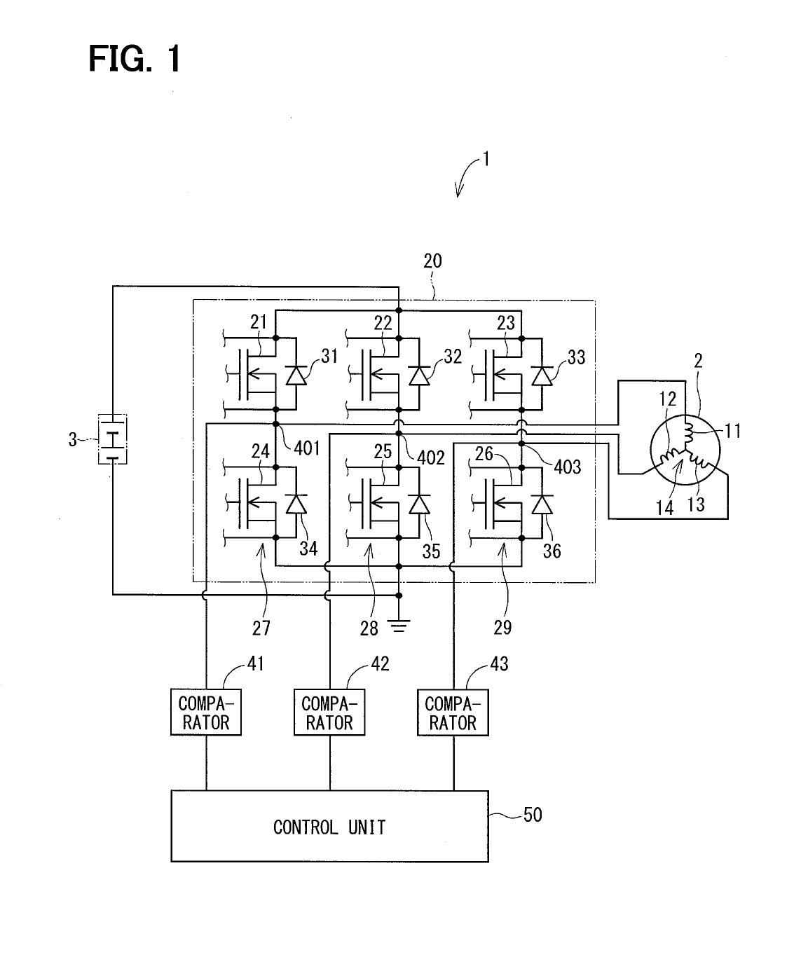

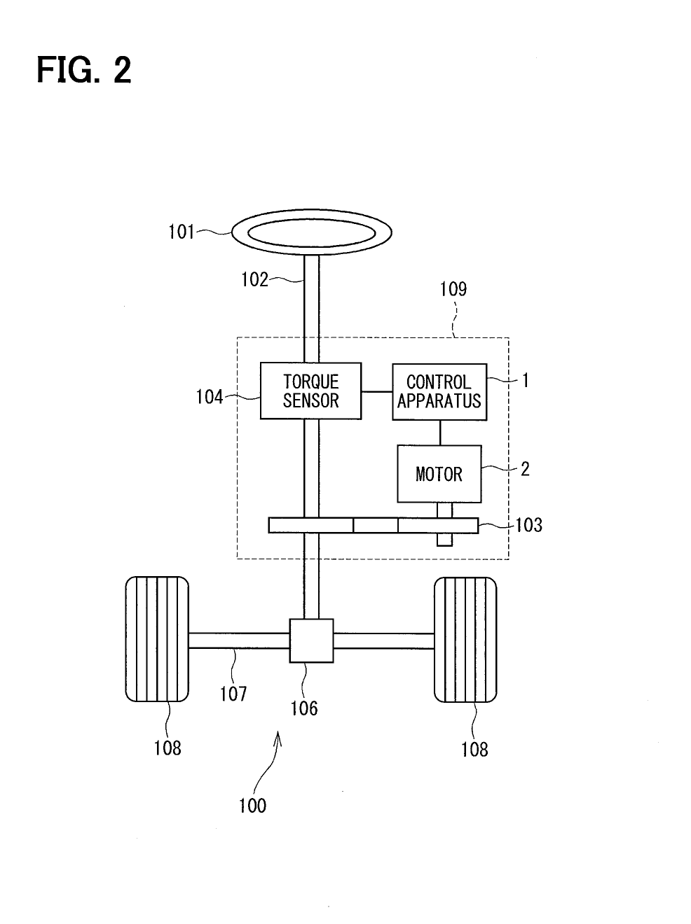

A rotary electric machine control apparatus according to a first embodiment is shown in FIG. 1. A rotary electric machine control apparatus 1 is configured to control electric power supplied to a motor 2 as a rotary electric machine to control driving of the motor 2. The rotary electric machine control apparatus 1 is used in an electric power steering system 109, which power-assists a steering operation of a vehicle, for example, together with the motor 2. This electric power steering system 109 is provided a part of a steering system 100 as shown in FIG. 2.

The steering system 100 is formed of a steering wheel 101, a steering shaft 102, a pinion gear 106, a rack shaft 107, tire wheels 108, the electric power steering system 109 and the like.

The steering wheel 101 is coupled to the steering shaft 102. A torque sensor 104 is provided on the steering shaft 102 for detecting a steering torque inputted by a driver's steering operation on the steering wheel 101. The pinion gear 106 is provided at one end of the steering shaft 102 and engaged with the rack shaft 107. A pair of tire wheels 108 is coupled to both ends of the rack shaft 107 through tie rods and the like. With this configuration, when the steering wheel 101 is rotated by the driver, the steering shaft 102 connected to the steering wheel 101 is rotated. A rotational motion of the steering shaft 102 is converted into a linear motion of the rack shaft 107 by the pinion gear 106 so that the pair of tire wheels 108 is steered by an angle corresponding to an amount of movement of the rack shaft 107.

The electric power steering system 109 is formed of the motor 2, which outputs an assist torque for assisting the driver's steering operation of the steering wheel 101, the rotary electric machine control apparatus 1 for controlling the driving of the motor 2, a reduction gear 103 for reducing the rotation of the motor 2 and transferring the reduced rotation to the steering shaft 102 or the rack shaft 107, and the like.

The motor 2 is a three-phase brushless motor, for example, and has a rotor and a stator, which are not shown. The rotor is a disk-shaped part, on which permanent magnets are mounted to provide magnetic poles. The stator accommodates the rotor therein and supports the rotor rotatably. The stator has parts protruded in the radially inward direction and arranged at every predetermined angular interval in the circumferential direction. A U-phase coil 11, a V-phase coil 12 and a W-phase coil 13, which are shown in FIG. 1, are wound about the protruded parts. The U-phase coil 11, the V-phase coil 12 and the W-phase coil 13 are windings, which correspond to the U-phase, the V-phase and the W-phase, respectively, and form a winding set 14 in combination.

The motor 2 is driven with electric power supply form a battery 3 (FIG. 1) as an electric power source. The motor 2 rotates the reduction gear 103 in both normal and reverse directions. The electric power steering system 109 outputs the assist torque from the motor 2 for assisting the steering operation of the steering wheel 101 in accordance with signals of the torque sensor 104 and a vehicle speed sensor for detecting a vehicle speed. The electric power steering system 109 transfers the torque to the steering shaft 102 or the rack shaft 107.

The rotary electric machine control apparatus 1 will be described next with reference to FIG. 1. The rotary electric machine control apparatus 1 includes an inverter 20, comparators 41, 42, 43, a control unit 50 and the like. The inverter 20 includes switching elements 21 to 26. The inverter 20 is a three-phase inverter, in which the six switching elements 21 to 26 are connected in a bridge form to switchover current supply to the U-phase coil 11, the V-phase coil 12 and the W-phase coil 13. The switching elements 21 to 26 are MOSFETs (metal-oxide-semiconductor field-effect transistors), which are one type of field effect transistors. The switching elements 21 to 26 are referred to as FETs 21 to 26.

Drains of the three FETs 21 to 23 are connected to a high-potential side of the battery 3. Sources of the FETs 21 to 23 are connected to drains of the FETs 24 to 26, respectively. Sources of the FETs 24 to 26 are connected to the ground. A U-phase junction point 401, which is a connection point of paired FET 21 and FET 24, is connected to one end of the U-phase coil 11. A V-phase junction point 402, which is a connection point of paired FET 22 and FET 25, is connected to one end of the V-phase coil 12. A W-phase junction point 403, which is a connection point of paired FET 23 and FET 26, is connected to one end of the W-phase coil 13.

Here, the FETs 21 to 23 connected to the high-potential side correspond to first switching elements, respectively. The FETs 24 to 26 connected to the low-potential side correspond to second switching elements, respectively. Each of the FETs 21 to 23, which are the first switching elements, is referred to a high side FET (H-FET). Each of the FETs 24 to 26, which are the second switching elements, is referred to as a low-side FET (L-FET), respectively. Further, each FET is identified with its phase like a U-H-FET 21, for example. The combination of the H-FET 21 and the L-FET 24 connected in series is referred to as a switching element pair 27. The combination of the H-FET 22 and the L-FET 25 is referred to as a switching element pair 28. The combination of the H-FET 23 and the L-FET 26 is referred to as a switching element pair 29.

FETs 21 to 26 are controlled to turn on and off by the control unit 50. A dead time period DT is set so that the paired H-FETs 21 to 23 and L-FETs 24 to 26 are both turned off at the time of ON-OFF switching of the FETs 21 to 26 thereby to prevent a short circuit between the high-potential side and the low-potential side, which is caused by turn-on of the switching element pair, for example, paired H-FET 21 and L-FET 24, at the same time. For example, when an operation state (ON-OFF state) is switched over from a state that the U-H-FET 21 is ON and the U-L-FET 24 is OFF to a state that the U-H-FET 21 is OFF and the U-L-FET 24 is ON, the U-L-FET 24 is turned on only after the dead time period DT. Thus, the U-H-FET 21 and the U-L-FET 24 are both remain in the OFF-state during the dead time period DT. The same operation is performed when a switchover is made from a state that the U-H-FET 21 is OFF and the U-L-FET 24 is ON to a state that the U-H-FET 21 is ON and the U-L-FET 24 is OFF. The same operations are performed for the V-phase and the W-phase as well.

The FETs 21 to 26 have parasitic diodes (rectifiers) between the sources and the drains, respectively. Diodes 31 to 36 are parasitic diodes of the FETs 21 to 26, respectively. The forward direction of the diodes 31 to 36 is from the source side to the drain side.

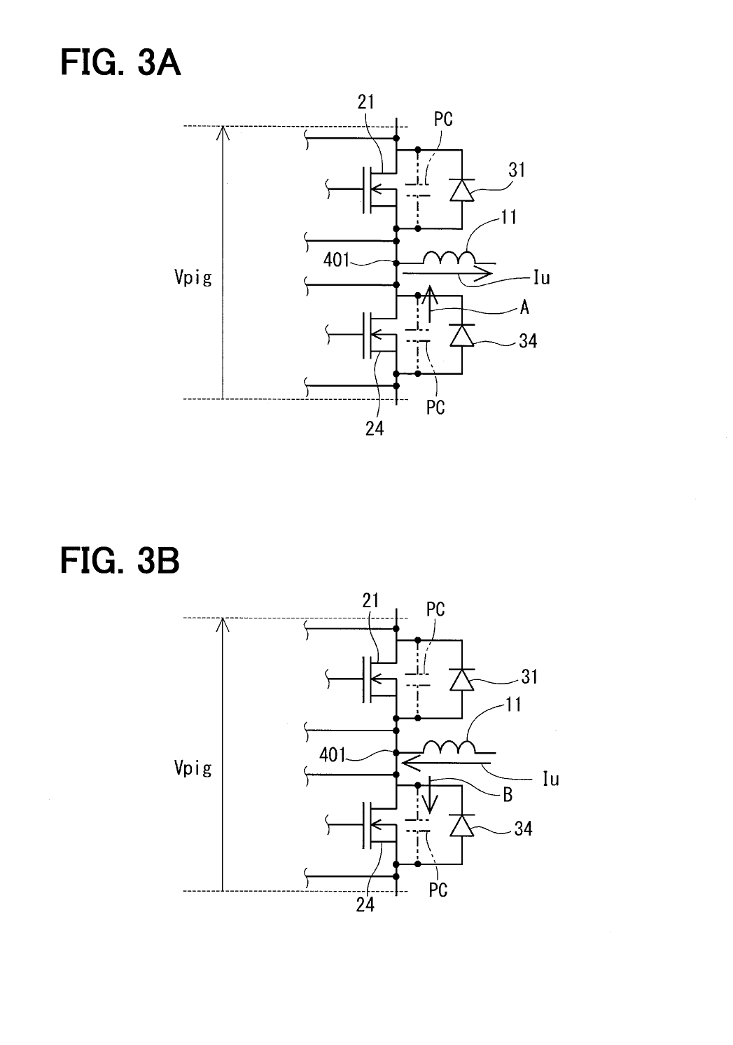

The FETs 21 to 26 also have parasitic capacitances, respectively. As shown by two-dot chain line in FIG. 3A, it is assumed that the parasitic capacitors PC are connected in parallel to the FETs 21 to 26. Although only the U-phase is shown in FIG. 3A, the V-phase and the W-phase similarly have parasitic capacitances.

Referring to FIG. 1, the comparator 41 is connected to the U-phase junction point 401 and acquires a U-phase terminal voltage Vu, which is developed at the U-phase junction point 401. The comparator 42 is connected to the V-phase junction point 402 and acquires a V-phase terminal voltage Vv, which is developed at the V-phase junction point 402. The comparator 43 is connected to the W-phase junction point 403 and acquires a W-phase terminal voltage Vw, which is developed at the W-phase junction point 403. The comparators 41 to 43 thus operate as terminal voltage acquisition parts. The U-phase terminal voltage Vu, the V-phase terminal voltage Vv and the W-phase terminal voltage Vw are referred to as phase terminal voltages.

The comparators 41 to 43 compare the inputted phase terminal voltages Vu, Vv and Vw with a first predetermined threshold voltage Vth1 and output comparison results to the control unit 50. The comparators 41 to 43 output low-level signals (L) when the phase terminal voltages Vu, Vv and Vw are equal to or lower than the threshold voltage Vth1, respectively. The comparators 41 to 43 output high-level signals (H) when the phase terminal voltages Vu, Vv and Vw are higher than the threshold voltage Vth1, respectively.

The threshold voltage Vth1 is set to be a value, which is between the low-potential side voltage of the L-FETs 24 to 26, and the high-potential side voltage of the H-FETs 21 to 23. The low-potential sides of the L-FETs 24 to 26 are connected to the ground. The high-potential sides of the H-FETs 21 to 23 are connected the positive polarity of the battery 3. For this reason, the threshold voltage Vth1 is set to be between the ground voltage Vg (about 0 [V]) and the battery voltage Vpig.

The control unit 50 includes a pre-driver, which is a drive circuit for the motor 2, a microcomputer, which executes various arithmetic operations, and the like. The control unit 50 controls ON-OFF operations of the FETs 21 to 26, which form the inverter 20, thereby to convert the DC power of the battery 3 and controls driving of the motor 2. The control unit 50 is provided primarily for controlling driving of the motor 2 of the electric power steering system 109.

The control unit 50 is configured to include a signal acquisition part, which acquires signals from various sensors such as the torque sensor 104. The control unit 50 calculates a command current based on the various signals such as the torque signal acquired from the torque sensor 104 so that the motor 2 outputs the assist torque for assisting the steering operation of the steering wheel 101. The control unit 50 controls the ON-OFF operations of the FETs 21 to 26 of the inverter 20 so that a current corresponding to the calculated command current is supplied to the U-phase coil 11, the V-phase coil 12 and the W-phase coil 13 of the motor 2. Thus, a U-phase current Iu, a V-phase current Iv and a W-phase current Iw are supplied to the U-phase coil 11, the V-phase coil 12 and the W-phase coil 13, respectively. As a result, the motor 2 is driven to rotate. The torque generated by rotation of the motor 2 is applied to the steering shaft 102 or the rack shaft 107 as the assist torque. The U-phase current Iu, the V-phase current Iv and the W-phase current Iw are actual currents, which actually flow in the U-phase coil 11, the V-phase coil 12 and the W-phase coil 13, respectively. The U-phase current Iu, the V-phase current Iv and the W-phase current Iw are referred to as phase currents Iu, Iv and Iw, respectively.

The control unit 50 determines the flow direction, that is, current supply direction, of the U-phase current Iu flowing to the U-phase coil 11 based on the output signal from the comparator 41. The control unit 50 determines the flow direction of the V-phase current Iv flowing to the V-phase coil 12 based on the output signal from the comparator 42. The control unit 50 determines the flow direction of the W-phase current Iw flowing to the W-phase coil 13 based on the output signal from the comparator 41.

Since the motor 2 includes inductive components and the like, each of the phase currents Iu, Iv and Iw flowing in the U-phase coil 11, the V-phase coil 12 and the W-phase coil 13 of the motor 13 deviates in phase from the command current related to each phase of the motor 2. It is taken into consideration that the change in the terminal voltages Vu, Vv and Vw in the dead time period DT differ in correspondence to the flow direction of the phase currents Iu, Iv and Iw. Thus, the flow directions of the phase currents Iu, Iv and Iw are determined based on the phase terminal voltages Vu, Vv and Vw developed in the dead time period DT. By further detecting time point of change in the flow directions, the phase difference between the command current and the actual current of each phase is detected to correct the phase difference.

The flow direction of current will be described first.

As shown in FIG. 3A, a current flow from the U-phase junction point 401 side to the U-phase coil 11 side, that is, a current flow from the inverter 20 side to the motor 2 side, is assumed to be positive in respect to polarity of a current. Similarly, as shown in FIG. 3B, a current flow from the U-phase coil 11 side to the U-phase junction point 401 side, that is, a current flow from the motor 2 side to the inverter 20 side, is assumed to be negative in respect to polarity of a current. The same is true for the V-phase and the W-phase as well.

A current flow direction determination method will be described below with reference to the U-phase as one example. The flow direction of the U-phase current Iu is determined based on the U-phase voltage Vu developed in the dead time period DT at the time of state change from the state that the U-H-FET 21 is OFF and the U-L-FET 24 is ON to the state that the U-H-FET 21 is ON and the U-L-FET 24 is OFF.

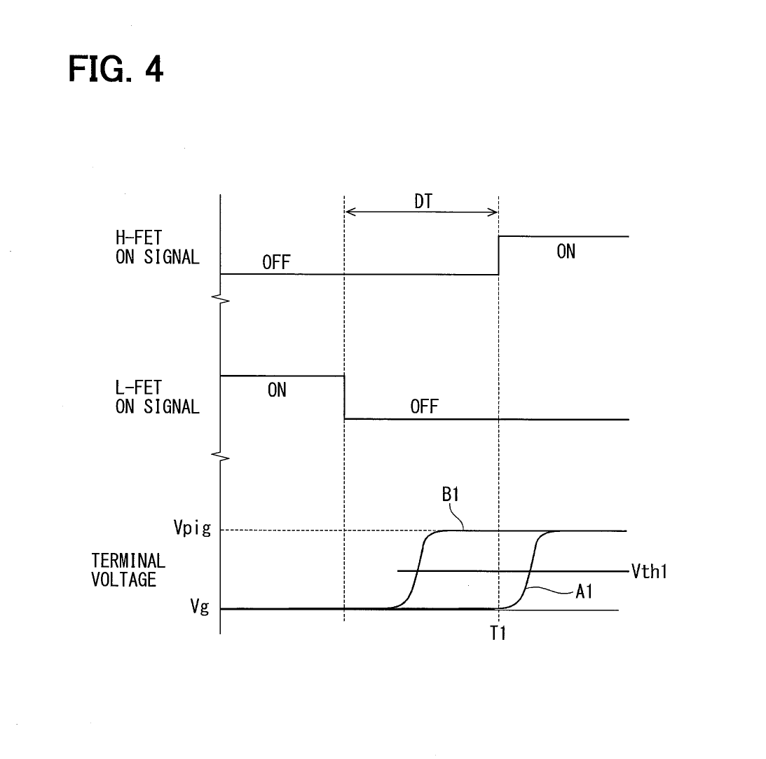

When the U-H-FET 21 is OFF and the U-L-FET 24 is ON as shown in FIG. 4, the U-phase voltage Vu is close to the ground voltage Vg (that is, 0 [V]). As shown in FIG. 3A, when the polarity of the U-phase current Iu is positive, that is, when the flow direction of the U-phase current Iu is from the U-phase junction point 401 side to the U-phase coil 11 side, the charge of the parasitic capacitor PC or the like of the U-L-FET 24 is likely to be continuously discharged to the motor 2 in the dead time period DT as indicated by an arrow A. As a result, as indicated by a symbol Al in FIG. 4, the U-phase voltage Vu does not increase but remains near the ground voltage Vg during the dead time period DT. When the dead time period DT ends and the U-H-FET 21 is turned on, the U-phase voltage Vu increases closely to the battery voltage Vpig, which is the high-potential side voltage of the battery 3.

As shown in FIG. 3B, when the polarity of the U-phase current Iu is negative, that is, when the flow direction of the U-phase current Iu is from the U-phase coil 11 side to the U-phase junction point 401 side, the charge of the parasitic capacitor PC or the like of the U-L-FET 24 is likely to be continuously charged in the dead time period DT as indicated by an arrow B. As a result, as indicated by a symbol B1 in FIG. 4, the U-phase voltage Vu increases above the ground voltage Vg during the dead time period DT.

The control unit 50 determines the flow direction of the U-phase current Iu based on the U-phase voltage Vu at the time point T1, which is immediately before the U-H-FET 21 is turned on. Specifically, as indicated by the symbol A1 in FIG. 4, when the U-phase voltage Vu at the time point T1, which is immediately before the turn-on of the U-H-FET 21, is lower than the threshold voltage Vth1, that is, when the output signal of the comparator 41 is the low level signal (L), the control unit 50 determines that the flow direction of the U-phase current Iu is from the U-phase junction point 401 side to the U-phase coil 11 side and the polarity of the current is positive. Further, as indicated by the symbol B1 in FIG. 4, when the U-phase voltage Vu at the time point T1, which is immediately before the turn-on of the U-H-FET 21, is higher than the threshold voltage Vth1, that is, when the output signal of the comparator 41 is the high-level signal (H), the control unit 50 determines that the flow direction of the U-phase current Iu is from the U-phase coil 11 side to the U-phase junction point 401 side and the polarity of the current is negative.

The time point T1, which is immediately before the FET 21 to 26 is turned on, will be described here. When each of the FETs 21 to 26 is controlled to turn on and off by the pre-driver (control unit 50), there arises a time delay from when an ON-signal for turning on the FET 21 to 26 is outputted from the microcomputer (control unit 50) to when the FET 21 to 26 actually turns on. For this reason, the time point when the ON-signal is outputted from the microcomputer is assumed to be the time point, which is immediately before the FET 21 to 26 is turned on. At the time point immediately before the FET 21 to 26 is turned on, both the H-FET 21 to 23 and the L-FET 24 to 26, which are paired, are OFF. This time point is thus assumed to be in the dead time period DT and after the predetermined time from the start of the dead time period.

The control unit 50 stores the polarity of the U-phase current Iu in its memory, which is not shown. The control unit 50 detects, as the switchover time point of switchover of the flow direction of the U-phase current Iu, the time point of switchover of the polarity of the U-phase current Iu from positive to negative and the time point of switchover from negative to positive, that is, the time point of reversal of the polarity of the U-phase current Iu. At the switchover time point, the U-phase current Iu, which is the actual current, is assumed to be 0 [A]. The control unit 50 can detect the phase of the U-phase current Iu by detecting the switchover time point at which the U-phase current Iu is 0 [A]. The control unit 50 further detects a phase difference between the

U-phase command current and the U-phase current Iu based on the switchover time point, at which the U-phase current Iu is assumed to be 0 [A], and the time point, at which the U-phase command current is 0 [A]. The U-phase command current, the phase difference of which is corrected, is feedback-controlled so that the phase of the U-phase current Iu becomes the desired phase. For example, when the phase of the U-phase current ill is delayed from the desired phase, the phase of the U-phase command current is advanced. The inverter 20 is controlled based on the corrected U-phase command current thereby to correct the phase of the U-phase current Iu flowing in the U-phase coil 11. Thus the torque outputted from the motor 2 can be regulated to the desired value. Although the determination of current flow, the detection of switchover time point and the correction of phase difference are described with reference to the U-phase as an example, the same operations are made for the V-phase and the W-phase.

The first embodiment are summarized as follows.

(1) The rotary electric machine control apparatus 1 is for controlling the driving of the motor 2, which has the winding set 14 formed of the U-phase coil 11, the V-phase coil 12 and the W-phase coil 13 corresponding to plural phases, and includes the inverter 20, the comparators 41 to 43 and the control unit 50.

The inverter 20 includes plural switching elements 21 to 26 forming the switching element pairs 27 to 29 in correspondence to the three phases of the U-phase coil 11, the V-phase coil 12 and the W-phase coil 13. The pairs 27 to 29 are formed of the H-FETs 21 to 23 provided at the high-potential side and the L-FETs 24 to 26 provided at the low-potential side. The comparators 41 to 43 acquire, as terminal voltage acquisition part, the terminal voltages Vu, Vv and Vw, which are the voltages developed at the junction points 401 to 403 between the H-FETs 21 to 23 and the L-FETs 24 to 26. The junction points 401 to 403 are connected to one ends of the U-phase coil 11, the V-phase coil 12 and the W-phase coil 13, respectively. The control unit 50 controls, as a drive control part, driving of the motor 2 by controlling the ON-OFF operations of the switching elements 21 to 26 based on the command current related to the driving of the motor 2. The control unit 50 determines, as a current flow direction determination part, the current flow direction at the time of ON-OFF switchover of the H-FETs 21 to 23 and the L-FETs 24 to 26, that is, the flow directions of the phase currents Iu, Iv and Iw supplied to the U-phase coil 11, the V-phase coil 12 and the W-phase coil 13 of the corresponding phases based on the phase terminal voltages Vu, Vv and Vw developed in the dead time period DT, in which the paired H-FETs 21 to 23 and L-FETs 24 to 26 are both turned off.

The flow direction of each phase current Iu, Iv and Iw is determined based on each phase terminal voltage Vu, Vv and Vw developed in the dead time period DT, by taking into consideration that the changes of the phase voltages Vu, Vv and Vw in the dead time period DT differ in correspondence to the flow directions of the phase currents Iu, Iv and Iw. Thus, the flow directions of the phase currents Iu, Iv and Iw flowing in the U-phase coil 11, the V-phase coil 12 and the W-phase coil 13 can be determined without using electronic components such as shunt resistors related to current detection. As a result, the number of components can be reduced, the rotary electric machine control apparatus 1 can be sized small and manufactured in less costs.

(2) The control unit 50 detects, as a switchover detection part, the switchover, specifically the switchover time point, at which the current flow direction is switched over. The control unit 50 further corrects, as a phase difference correction part, the phase difference between the command current and each phase current Iu, Iv and Iw based on the switchover time point.

Each phase difference between the command current and the phase current Iu, Iv and Iw can be detected by detecting the switchover time point, at which the flow direction of the phase current Iu, Iv, and Iw is switched over, that is, the time point, at which the phase current Iu, Iv and Iw becomes 0 [A]. The phase differences between the command current and the phase current Iu, Iv and Iw is corrected by the feedback control so that the phase currents Iu, Iv and Iw attain the desired phases, respectively. As a result, the torque outputted by the motor 2 can be controlled to the desired value and the driving of the motor 2 can be controlled with high precision.

(3) The control unit 50 determines that the U-phase current Iu flows from the U-phase junction point 401 side to the U-phase coil 11 side when the U-phase voltage Vu in the dead time period DT is equal to or lower than the threshold voltage Vth1. The control unit 50 determines that the U-phase current Iu flows from the U-phase coil 11 side to the U-phase junction point 401 side when the U-phase voltage Vu in the dead time period DT is higher than the threshold voltage Vth1. Similarly, the control unit 50 determines that the V-phase current Iv flows from the V-phase junction point 402 side to the V-phase coil 12 side when the V-phase voltage Vv in the dead time period DT is equal to or lower than the threshold voltage Vth1. The control unit 50 determines that the V-phase current Iv flows from the V-phase coil 12 side to the V-phase junction point 402 side when the V-phase voltage Vv in the dead time period DT is higher than the threshold voltage Vth1. Similarly, the control unit 50 determines that the W-phase current Iw flows from the W-phase junction point 403 side to the W-phase coil 13 side when the W-phase voltage Vw in the dead time period DT is equal to or lower than the threshold voltage Vth1. The control unit 50 determines that the W-phase current Iw flows from the W-phase coil 13 side to the W-phase junction point 403 side when the W-phase voltage Vw in the dead time period DT is higher than the threshold voltage Vth1. It is thus possible to determine the flow direction of each phase current Iu, Iv and Iw appropriately by comparing each phase voltage Vu, Vv and Vw with the threshold voltage Vth1.

(4) The control unit 50 determines the flow direction based on each terminal voltage Vu, Vv and Vw in the dead time period DT, at which the

ON-OFF state changes from the state that the H-FETs 21 to 23 are OFF and the L-FETs 24 to 26 are ON to the state that the H-FETs 21 to 23 are ON and the L-FETs 24 to 26 are OFF. When the polarity of current is negative, the charge is charged in the parasitic capacitor PC and the like during the dead time period DT. When the polarity of current is positive, the charge is not charged in the parasitic capacitor and the like during the dead time period DT It is thus possible to determine the flow direction of each phase current Iu, Iv and Iw based on each phase terminal voltage Vu, Vv and Vw.

(5) The control unit 50 determines the flow direction of each phase current Iu, Iv and Iw based on each phase voltage Vu, Vv and Vw, which is developed after the predetermined time from the start of the dead time period DT within the dead time period DT. The predetermined time is preferably set to be longer than a period, which is required for the parasitic capacitor PC and the like are charged and each phase voltage Vu, Vv and Vw increases, in the case that the polarity of the current is negative. Thus, the flow direction of each phase current Iu, Iv and Iw can be determined accurately based on each phase voltage Vu, Vv and Vw.

(6) The rotary electric machine control apparatus 1 is used in the electric power steering system 109. The electric power steering system 109 includes the rotary electric machine control apparatus 1 and the motor 2, which outputs the assist torque for the steering operation. The rotary electric machine control apparatus 1 can be sized small and hence can be mounted easily within a limited space of the electric power steering system 109.

### Second Embodiment

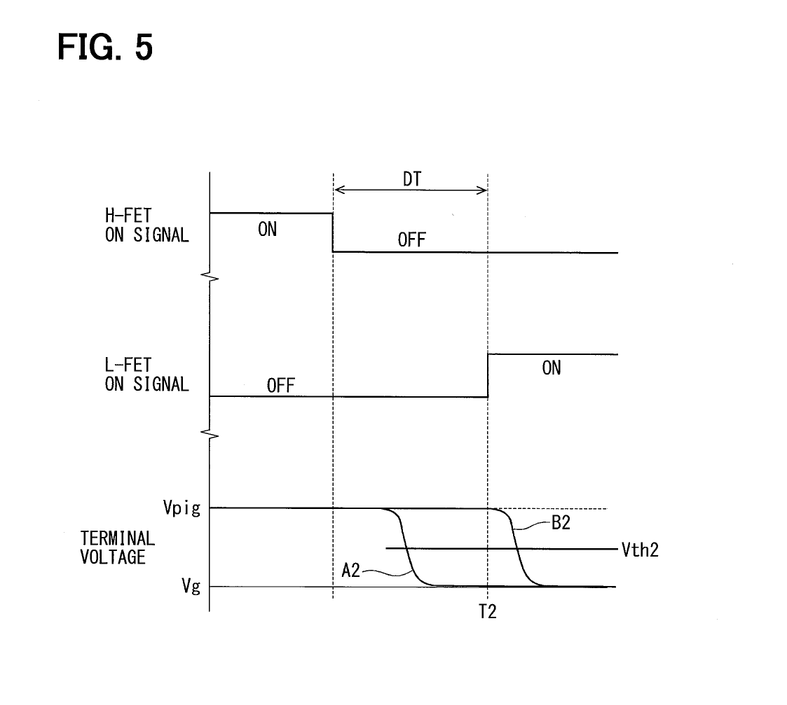

A second embodiment of the rotary electric machine control apparatus will be described with reference to FIG. 5, etc.

Since the second embodiment is different from the first embodiment in the method of current flow direction determination, mainly this difference will be described by simplifying the description of other configuration, etc. Similarly to the above-described embodiment, the description will be made with respect to the U-phase as an example.

In the first embodiment, the flow direction of the U-phase current Iu is determined based on the U-phase voltage Vu in the dead time period DT at the time of switchover of states from the state that the U-H-FET 21 is OFF and the U-L-FET 24 is ON to the state that U-H-FET 21 is ON and the U-L-FET 24 is OFF. In the second embodiment, the flow direction of the U-phase current Iu is determined based on the U-phase voltage Vu in the dead time period DT at the time of switchover of states from the state that the U-H-FET 21 is ON and the U-L-FET 24 is OFF to the state that U-H-FET 21 is OFF and the U-L-FET 24 is ON. As shown in FIG. 5, the U-phase voltage Vu is close to the battery voltage Vpig since the U-H-FET 21 is ON and the U-L-FET 24 is OFF. As shown in FIG. 3A, when the polarity of the U-phase current Iu is positive, that is, when the flow direction of the U-phase current Iu is from the U-phase junction point 401 side to the U-phase coil 11 side, the charge of the parasitic capacitor PC or the like of the U-L-FET 24 is likely to be continuously discharged in the dead time period DT as indicated by the arrow A. As a result, as indicated by a symbol A2 in FIG. 5, the U-phase voltage Vu decreases to be lower than the battery voltage Vpig during the dead time period DT.

As shown in FIG. 3B, when the polarity of the U-phase current Iu is negative, that is, when the flow direction of the U-phase current Iu is from the U-phase coil 11 side to the U-phase junction point 401 side, the charge of the parasitic capacitor PC or the like of the U-L-FET 24 is continuously charged in the dead time period DT as indicated by the arrow B. As a result, as indicated by a symbol B2 in FIG. 5, the U-phase voltage Vu does not decrease but remains at about the battery voltage Vpig during the dead time period DT. When the dead time period DT ends and U-L-FET 24 is turned on, the U-phase voltage Vu decreases close to the ground voltage Vg.

The control unit 50 determines the flow direction of the U-phase current Iu based on the U-phase voltage Vu at the time of switchover time point T2, which is immediately before the U-L-FET 24 is turned on. Specifically, as indicated by the symbol A2 in FIG. 5, when the U-phase voltage Vu at the time point T2, which is immediately before the turn-on of the U-L-FET 24, is lower than the threshold voltage Vth2, that is, when the output signal of the comparator 41 is the low-level signal (L), the control unit 50 determines that the flow direction of the U-phase current Iu is from the U-phase junction point 401 side to the U-phase coil 11 side and the polarity of the current is positive. Further, as indicated by the symbol B2 in FIG. 5, when the U-phase voltage Vu at the time point T2, which is immediately before the turn-on of the U-L-FET 24, is higher than the threshold voltage Vth2, that is, when the output signal of the comparator 41 is the high-level signal (H), the control unit 50 determines that the flow direction of the U-phase current Iu is from the U-phase coil 11 side to the U-phase junction point 401 side and the polarity of the current is negative. The detection of switchover time point, the correction of phase difference and the like are made similarly to the above-described embodiment. Although the description is made with reference to the present embodiment with reference to the U-phase as an example, the same operations are made for the V-phase and the W-phase.

According to the second embodiment, the control unit 50 determines the flow direction based on each terminal voltage Vu, Vv and Vw in the dead time period DT, at which the ON-OFF state changes from the state that the H-FET 21 to 23 is ON and the L-FET 24 to 26 is OFF to the state that the H-FET 21 to 23 is OFF and the L-FET 24 to 26 is ON. When the polarity of current is positive, the charge of the parasitic capacitor PC and the like in the dead time period DT is discharged. When the polarity of current is negative, the charge of the parasitic capacitor PC and the like is not discharged during the dead time period DT. It is thus possible to determine the flow direction of each phase current Iu, Iv and Iw based on each phase terminal voltage Vu, Vv and Vw.

Similarly to (5) of the first embodiment, the control unit 50 determines the flow direction of each phase current Iu, Iv and Iw based on each phase voltage Vu, Vv and Vw, which is developed after the predetermined time from the start of the dead time period DT within the dead time period DT. The predetermined time is preferably set to be longer than a period, which is required for the parasitic capacitor PC and the like are discharged and each phase voltage Vu, Vv and Vw decreases, in the case that the polarity of the current is positive. Thus, the second embodiment also provides the similar advantage as the above-described embodiment.

### Other Embodiment

(A) According to the first embodiment, as one example, the flow direction of the actual current supplied to the coil is determined based on the terminal voltage developed in the dead time period, in which the ON-OFF states are switched over from the state that the high-side FET is OFF and the low-side FET is ON to the state that the high-side FET is ON and the low-side FET is OFF. According to the second embodiment, as another example, the flow direction of the actual current supplied to the coil is determined based on the terminal voltage developed in the dead time period, in which the ON-OFF states are switched over from the state that the high-side FET is ON and the low-side FET is OFF to the state that the high-side FET is OFF and the low-side FET is ON. As the other embodiment, it is possible to determine the flow direction of the actual current supplied to the coil based on the terminal voltage developed in the dead time period by combining the first embodiment and the second embodiment. That is, the flow direction may be determined in the dead time period from the state that the high-side FET is OFF and the low-side FET is ON to the state that the high-side FET is ON and the low-side

FET is OFF and in the dead time period from the state that the high-side FET is ON and the low-side FET is OFF to the state that the high-side FET is OFF and the low-side FET is ON.

(B) The threshold voltage Vth1 in the first embodiment and the threshold voltage Vth2 in the second embodiment may be the same or different. The threshold voltage may be different from phase to phase or the same among the phases.

(C) According to the first embodiment, the flow direction of the actual current flowing in the coil is determined based on the terminal voltage developed immediately before the H-FET is turned on. According to the second embodiment, the flow direction of the actual current flowing in the coil is determined based on the terminal voltage developed immediately before the L-FET is turned on. As the other embodiment, it may be taken into consideration that the change in the terminal voltage needs some time in the dead time period. Thus the flow direction of the actual current flowing in the coil may be determined based on the terminal voltage after an elapse of a predetermined time from a start of the dead time period. That is, the predetermined time is preferably set to be longer than a time period required for the change in the terminal voltage.

(D) In the above-described embodiments, the inputted phase terminal voltages are compared with the threshold voltages by the comparators, respectively. The comparators output the low-level signals (L) and the high-level signals (H) when the inputted phase terminal voltages are equal to or lower and higher than the threshold voltages, respectively. As the other embodiment, the phase terminal voltages may be applied to the input terminals of the comparators so that the comparators output the high-level signals (H) and the low-level signals (L) when the inputted phase terminal voltages are equal to or higher than and lower than the threshold voltages, respectively. In this case, when the output signal outputted from the comparator in the dead time period is the high-level signal (H), it is determined that the phase terminal voltage is equal to or lower than the threshold voltage and the polarity of current is positive. When the output signal is the low level signal (L), it is determined that the phase terminal voltage is higher than the threshold voltage and the polarity of current is negative.

(E) In the above-described embodiments, the control unit determines the flow direction of the actual current supplied to the coil based on the output signal of the comparator. As the other embodiment, the control unit may acquire the terminal voltage, calculate whether the terminal voltage is higher or lower than the threshold voltage and determine the flow direction of the actual current supplied to the coil based on a calculation result. That is, the control unit may be configured to operate as a terminal voltage acquisition circuit or like part as well. The flow direction of the actual current may be determined by any other methods as long as the determination in made based on the terminal voltage developed in the dead time period.

(F) In the above-described embodiments, the switching elements are MOSFETs. As the other embodiment, the switching elements may be IGBTs (Insulated Gate Bipolar Transistors), transistors or thyristors.

(G) In the above-described embodiments, the motor is the three-phase motor. As the other embodiment, the motor may be a multi-phase motor, which has four or more phases. In the above-described embodiments, the rotary electric machine is the motor. As the other embodiment, the rotary electric machine is not limited to the motor but may be a generator or a motor-generator, which has both functions of a motor and a generator.

(G) In the above-described embodiments, the motor is used for the electric power steering apparatus. As the other embodiment, the rotary electric machine may be used in any other system.

The above-described embodiments may further be implemented differently.

What is claimed is:

1. A rotary electric machine control apparatus for controlling driving of a rotary electric machine, which includes a winding set formed of plural coils corresponding to plural phases, the rotary electric machine control apparatus comprising:
an inverter including switching elements forming plural switching element pairs, each of which corresponds to each phase of the coils and is formed of a first switching element provided at a high-potential side and a second switching element provided at a low-potential side; and
a control unit including a terminal voltage acquisition part, a drive control part and a current flow direction determination part, the terminal voltage acquisition part acquiring a terminal voltage developed at each junction point, which is between the first switching element and the second switching element and connected to one end of the coil of the corresponding phase, the drive control part controlling the driving of the rotary electric machine by controlling ON-OFF operations of the switching elements based on a command current related to the driving of the rotary electric machine, and the current flow direction determination part for determining, at time of an ON-OFF switchover of the first switching element and the second switching element, a current flow direction of an actual current flowing in the coil of the phase corresponding to the terminal voltage based on the terminal voltage developed in a dead time period, in which the pair of the first switching element and the second switching element are both turned off.

2. The rotary electric machine control apparatus according to claim 1, wherein the control unit further includes:
a switchover detection part for detecting a switchover time point, at which the flow direction detected by the flow direction determination part, is switched over; and
a phase difference correction part for correcting a phase difference between the command current and the actual current.

3. The rotary electric machine control apparatus according to claim 1, wherein:
the current flow direction determination part determines that the actual current flows from a junction point side to a coil side when the terminal voltage developed in the dead time period is equal to or lower than a threshold voltage and that the actual current flows from the coil side to the junction point side when the terminal voltage developed in the dead time period is higher than the threshold voltage.

4. The rotary electric machine control apparatus according to claim 1, wherein:
the current flow direction determination part determines the flow direction based on the terminal voltage developed in the dead time period at time of a state switchover from a state that the first switching element is OFF and the second switching element is ON to a state that the first switching element is ON and the second switching element is OFF.

5. The rotary electric machine control apparatus according to claim wherein:
the current flow direction determination part determines that the actual current flows from a junction point side to a coil side when the terminal voltage developed in the dead time period is equal to or lower than a threshold voltage and that the actual current flows from the coil side to the junction point side when the terminal voltage developed in the dead time period is higher than the threshold voltage.

6. The rotary electric machine control apparatus according to claim 1, wherein:
the current flow direction determination part determines the flow direction based on the terminal voltage developed after a predetermined time from a start of the dead time period and in the dead time period.

7. An electric power steering system comprising:
the rotary electric machine control apparatus according to claim 1; and
a rotary electric machine for outputting an assist torque for assisting a steering operation.
